(19) United States
(12) Patent Application Publication
(10) Pub. No.: US 2016/0299927 A1
(43) Pub. Date: Oct. 13, 2016

(54) SERVICE ORIENTED FLAT FILE SYSTEM

(71) Applicant: INFOTRAX SYSTEMS, OREM, UT (US)

(72) Inventors: Larry Nash, Provo, UT (US); Dan Floyd, West Jordan, UT (US); Jake Stowell, Orem, UT (US); Mark Rawlins, Lehi, UT (US)

(21) Appl. No.: 14/683,746

(22) Filed: Apr. 10, 2015

(51) Int. Cl. G06F 17/30

(52) U.S. Cl. CPC G06F 17/30327; G06F 17/30477

(57) ABSTRACT

A server computer system receives a database query comprising multiple query fields. At least one of the query fields is directed towards information stored within a first hierarchal tree, and another of the query fields is directed towards information stored within a separate, second hierarchal tree. The server computer system can then access one or more files containing the first hierarchal tree and the second hierarchal tree. After accessing the hierarchal trees, the server computer system can identify a first group of query fields that are contained within the first hierarchal tree and a second group of query fields that are not contained within the first hierarchal tree. The first group of query fields and the second group of query fields are selected from the multiple query fields and the at least one of the query fields is within the first group of query fields.

### BACKGROUND OF THE INVENTION

1. Technical Field

The present invention relates generally to computer-based database systems.

2. Background and Relevant Art

Many businesses store hierarchically organized data in databases where any entry (or row) may be the parent of one or more child entries (or rows) within the database. A typical hierarchically organized database stores data in a relational database table. Although standard relational database access techniques can be used to access and process hierarchical data stored in this manner, these techniques can be slow especially when the hierarchical structure is large.

These slower techniques that have been used for accessing and processing hierarchical data have limited the number and type of real-time applications that consume the hierarchical data. In one example, multi-level marketing companies maintain hierarchical data structures representing the hierarchy of individuals participating in the multi-level marketing business.

A typical hierarchical database will store many different pieces of data for each individual such as the total amount of sales for the individual in a specified period, a number of new customers obtained in a specified period, etc. One common computation performed on the hierarchical data is the calculation of commissions based on the total amount of sales for each individual. One individual's commission is generally based not only on the individual's sales, but the sales of other individuals under the individual in the hierarchy. In a large hierarchy, it may take a relatively long time to calculate the commission, or to calculate another figure that is dependent on the hierarchical relationships, for an individual. Additionally, in some cases, sales data may be stored within multiple independent hierarchies, requiring that data gathering and calculations be performed on multiple hierarchies, and requiring multiple requests directed towards each individual hierarchy.

For at least these and other reasons, many functions cannot be provided in real-time. Specifically, conventional databases make it difficult or impossible to provide or display certain real-time information such as commissions for individuals in a multi-level marketing organization, in particular, when data is split between multiple independent hierarchies. Accordingly, there are a number of disadvantages with organizational databases that can be addressed.

### BRIEF SUMMARY OF THE INVENTION

The present invention extends to methods, systems, and computer program products for accessing hierarchical data in an expedited way. In particular, implementations of the present invention involve the use of system-oriented queries within a hierarchal database. For example, implementations of the present invention involve efficiently applying a single query against multiple hierarchies.

In one implementation, a server computer system receives a database query comprising multiple query fields. At least one of the query fields is directed towards information stored within a first hierarchal tree, and another of the query fields is directed towards information stored within a separate, second hierarchal tree based on the same hierarchal data structure. The server computer system can then access one or more files containing both the first hierarchal tree and the second hierarchal tree. After accessing the hierarchal trees, the server computer system can identify a first group of query fields that are contained within the first hierarchal tree and a second group of query fields that are not contained within the first hierarchal tree. The first group of query fields and the second group of query fields are selected from the multiple query fields and the at least one of the query fields is within the first group of query fields.

Additionally, the server computer system can retrieve, from the first hierarchal tree, a first set of data entries from one or more query fields that are within the first group of query fields. The server computer system can then retrieve, from the second hierarchal tree, a second set of data entries from one or more queries that are within the second group of queries. The server computer system can then transmit a single query response that comprises the first set of data entries and the second set of data entries. The first set of data entries and the second set of data entries being responsive to the database query.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computer environment in which the present invention may be implemented;

FIG. 2 illustrates exemplary hierarchically organized data and an exemplary ordered flat file derived from the data;

FIG. 3 illustrates a query being applied to multiple hierarchal tree structures;

FIG. 4 is a flowchart of an exemplary method implemented by one or more embodiments of the invention; and

FIG. 5 is a flowchart of another exemplary method implemented by one or more embodiments of the invention.

### DETAILED DESCRIPTION OF THE PREFERRED EMBODIMENTS

The present invention extends to methods, systems, and computer program products for accessing hierarchical data in an expedited way. In particular, implementations of the present invention involve the use of system-oriented queries within a hierarchal database. For example, implementations of the present invention involve efficiently applying a single query against multiple hierarchies.

Accordingly, one or more implementations of the present invention allow a user to submit inquiries to one or more hierarchal tree structures, without requiring the user to know which hierarchal tree, or combination of trees, contains the queried data. Additionally, implementations of the present invention allow a user to easily, with a single query, gather data from multiple hierarchal trees. One will understand that the ability to quickly access data from multiple hierarchal trees can provide significant benefits in many fields.

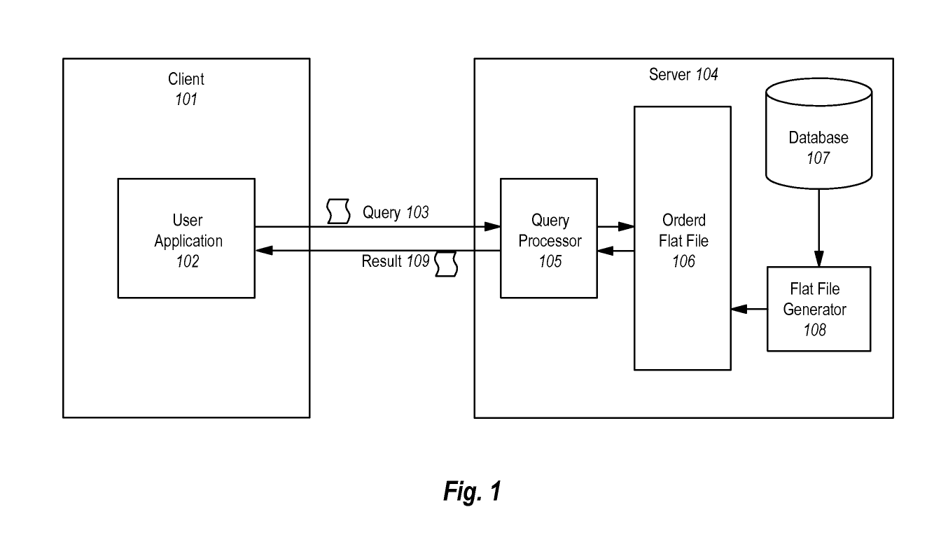

FIG. 1 illustrates a generalized computer environment including a client 101 and a server 104 according to embodiments of the present invention. Client 101 may be any computer including a desktop, laptop, smart phone, etc. User application 102 on client 101 is an application that sends queries to server 104 for viewing hierarchical data stored in database 107. For example, user application 102 may be a general purpose web browser, or may be a dedicated local or web-based application.

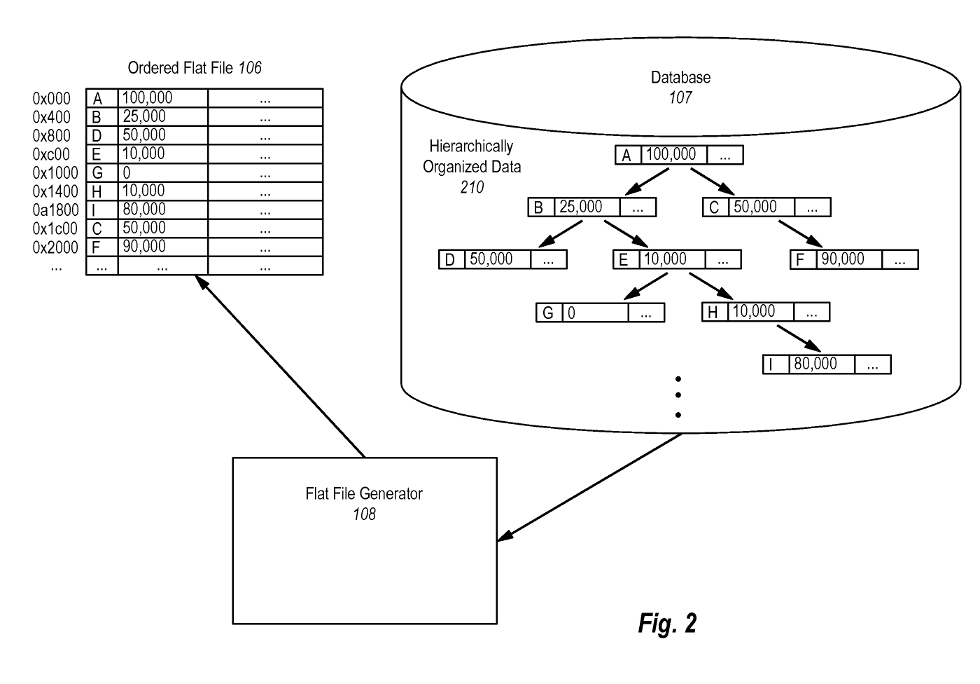

To expedite the processing of such queries, at least one implementation of the present invention involves use of a flat file generator 108 on server 104 to create and maintain an ordered flat file 106. The ordered flat file 106 stores at least some of the hierarchical data of the database 107 as a flat file that maintains the hierarchical organization of the data as will be further described below with reference to FIG. 2. When a query is received from user application 102, the query processor 105 on server 104 accesses the ordered flat file 106 to resolve the query rather than accessing the underlying data in database 107. In some implementations, after initially creating the flat file 106, the hierarchal data in the database 107 can be deleted.

FIG. 2 depicts a database 107, which stores exemplary hierarchically organized data 210. The hierarchically organized data comprises a plurality of elements that each has at least one parent child relationship with another element. FIG. 2 also illustrates an exemplary ordered flat file 106 created from the hierarchically organized data 210 by flat file generator 108. Hierarchically organized data 210 is shown as a tree structure for ease of illustration; however, an ordered flat file can be created from an underlying database of any type or format (e.g., relational, flat file, etc.). The ordered flat file 106 is structured such that all direct descendants of an element are listed directly below the element within the flat file. For example, because element A is the base node and all other elements are descendants of element A, it is listed first in the ordered flat file.

Next, element B is listed with all its direct descendants listed directly below it and prior to any other element that is at the same level or a higher level in the hierarchy than element B. For example, element C (which is at the same level as element B (i.e., a brother of element B)) is listed after all of element B's direct descendants (elements D, E, G, H, and I).

As depicted in FIG. 2, the various elements (A, B, D, E, . . . ) are depicted as being directly adjacent to each other in memory. In at least one implementation, however, the elements are not necessarily next to each other in memory. Instead, the various elements can be linked in the same order depicted in the ordered flat file 106 using pointers. For example, Element B can include a pointer to the memory location of element D and element A. Accordingly, Element B could identify that Element A is directly above it in the ordered flat file 106 and that Element D is directly below it.

In this way, any element's descendants can be quickly determined by reading the ordered flat file 106 until an element with the same or higher level in the hierarchy is reached. For example, it can quickly be determined that element I does not have any descendants because the next element below element I in the ordered flat file 106 is element C, which is a brother to element B, and is three levels higher than element I in the hierarchy.

In at least one implementation, each element within the ordered flat file can comprise a field that indicates the element's hierarchical parent. For example, element C can comprise a field that indicates that element A is element C's parent. As such, when traversing the ordered flat file from element I to element C, it can be determined that element C is not a child of element I, because C comprises an indication its parent is element A.

The listed fields in the ordered flat file 106 of FIG. 2 represent the element's name (or identifier) and a total sales amount for the person represented by the element. However, an ordered flat file can include any number of fields storing any type of data as indicated by the ellipses. For example, FIG. 2 illustrates an implementation in which each element in the ordered flat file 106 includes a field that defines the element's level in the hierarchy, or that may indicate a person's (represented by the element) title, rank, or position in a company structure, as well as other fields containing data that may be used to calculate reports. The ordered flat file 106 of FIG. 2 depicts elements that are 1 KB in size as represented by the hexadecimal addresses to the left of each element. However, any size may be allocated to elements in the hierarchy, and each element may in fact be a different size. One will appreciate that, in at least one embodiment, each element is the same size.

An ordered flat file can be particularly beneficial in representing a “downline” of an individual in a hierarchical organization, such as a multi-level marketing business structure. An individual's downline in a multi-level marketing hierarchy refers to the individual and all other individuals that fall below the individual in the hierarchy. Using the example of FIG. 1, element B's downline would include elements B, D, E, G, H, and I (but not C, F). As can be seen, this downline can quickly be determined by sequentially reading the ordered flat file from element B to element I and stopping before elements C and F.

Generally, it is quicker to access hierarchical data stored in an ordered flat file than it is to access the same data stored in an underlying database. Therefore, calculations based on hierarchical data, such as commissions as previously described, can be performed more quickly by creating an ordered flat file of the hierarchical data, and accessing the hierarchical data within the ordered flat file to generate the required result set.

An ordered flat file may be created from a hierarchical dataset stored in an underlying database at various times. For example, a multi-level marketing business may update its database with sales figures at the end of each business day. After the updates are entered each day, an ordered flat file may be generated to represent the state of the hierarchical data after the updates for that day are entered. Of course, an ordered flat file may be created at any interval. Additionally, in at least one embodiment, an existing flat file can be updated to reflect new information by individually accessing and updating each required data field.

Generally, a query for data of a hierarchical dataset requests a sub-portion of the hierarchical dataset. One example includes a query for an individual's downline. As described above, the sub-portion of hierarchical data can be obtained by reading a sequential portion of the ordered flat. To locate the beginning of the sequential portion to be read, a starting element must be identified. For example, to locate the beginning of element B's downline, element B must be identified in the ordered flat file.

At least two approaches can be taken to locate the beginning of the sequential portion: sequential and random access. Sequential access refers to reading from the beginning of the ordered flat file and continuing to read the elements in the ordered flat file until the first element of the sequential portion is identified. Once the first element is identified, any filtering conditions in the query can be applied to the elements in the portion as the elements are read.

Random access, on the other hand, refers to reading an element of the ordered flat file without first reading the preceding elements in the ordered flat file. Random access can be accomplished by maintaining a location index for each element in the ordered flat file. An element's location in the ordered flat file can be determined by reading the element's location within the index and then accessing the ordered flat file at the address provided by the index. In at least one implementation, the index and/or the flat file can be addressed as a hash map.

In either sequential or random access, once the first element of the sequential portion is identified, the remaining elements of the sequential portion can quickly be retrieved by sequentially reading the ordered flat file until an element that is at the same or higher level in the hierarchy is identified at which point no further reads need to be performed. As each element in the sequential portion is read, the filtering criteria can be applied to generate one or more result sets. In other words, only a single pass of the ordered flat file is required to identify the relevant portion and to apply the filtering criteria to the portion to generate one or more result sets.

As described above, implementations of the present invention provide methods and systems for quickly accessing data elements from within hierarchal tree structures. In addition to the ability to quickly access the data element, in at least one implementation, a user can access information from multiple hierarchal tree structures with a single query, and without necessarily knowing what specific data structure contain the respective data elements.

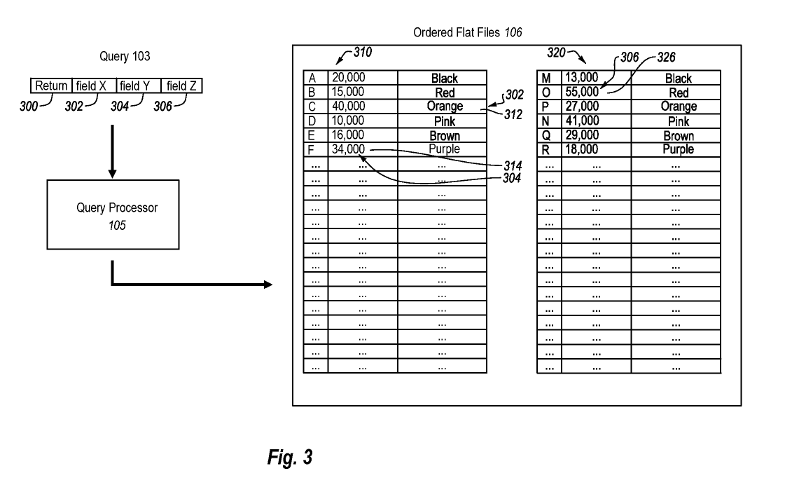

For example, FIG. 3 depicts a query 103 being processed against multiple ordered flat files 106. In particular, the query 103 comprises a “return” command 300, which is directed towards returning specified values from hierarchal data structures. The query 103 also comprises a field x query 302, a field y query 304, and a field z query 306. As depicted in FIG. 3, field x query 302 corresponds with data element 312 from flat file 310, field y query 304 corresponds with data element 314 from flat file 310, and field z query 306 corresponds with data element 326 from flat file 320. As such, the first two query fields 302, 304 are directed towards the same flat file 310, while the third query field 306 is directed towards another flat file 320.

Once the query processor 108 receives a query 103, the query processor 108 can automatically identify which flat files 106 contain the requested data fields. In at least one implementation, the query processor 105 can accomplish this by accessing a header file that is associated with each ordered flat file 106. The header file can contain a description of the data fields that are contained within the respective flat file 106. For example, a particular header file may describe a flat file 106 as comprising a quarterly sales data field for each of the employees of a business. Once the query processor 105 identifies that a particular data field is not located within a particular flat file, the query processor 105 can avoid searching the particular flat file for the identified data field.

In another implementation, the hierarchal data structures can be accessed using aliases and/or logical arguments. For example, an organization may create hierarchal data trees on a weekly basis that represent the weekly sales numbers. A specific query may be created that is supposed to compare the current weeks sales numbers with the previous weeks sales numbers. In at least one implementation, an alias such as “current_week_sales_numbers” can be associated with the newly created hierarchal data structure. Additionally, a user can access the previous week's sales numbers by using a bracket with a number indicator. For instance, “current_week_sales_numbers[1]” can be used to access the previous week's hierarchal data structures, and similarly, “current_week_sales_numbers[2]” can be used to access the sales numbers from two weeks previous. Using this method, and equivalents, a single query can be used indefinitely and still provide current results.

After identifying the appropriate ordered flat files 106, the query processor 105 can sequentially process each query, or process multiple queries simultaneously. In particular, the query processor 106 can access both order flat file 310 and ordered flat file 320 at the same time, and retrieve data elements from each flat file simultaneously.

In some cases, the query 103 may not be requesting specific individual data elements from the ordered flat files 106, but instead might be requesting sets of data. For example, referring to the hierarchically organized data 210 in FIG. 2, a query might be directed towards returning the individual sales amount for each person under person “E.” In this case, the query processor 105 can identify the appropriate flat file(s) where this data is stored, and access and return all of the appropriate data.

In an additional implementation, the query processor can perform mathematical functions on the gathered data. For example, in contrast to requesting the individual sales amount of each person under person “E,” a query might request the total amount of sales of everyone under person “E.” Accordingly, in this case, the query processor 105 would access the individual sales amounts and add them all together. The query processor 105 can then provide the query results 109 (shown in FIG. 1) back to the user application 102.

In at least one implementation, when returning a result 109, the query processor can return the result as a single result, even though the initial query 103 may be been directed towards multiple hierarchal tree data structures. For example, the query 103 from FIG. 3 includes three query fields 302, 304, 306 directed towards query fields that are within two different hierarchal tree structures. In response to the single query 103, the query processor 105 can return a single query result 109 that comprises the data elements 312, 314, 326 that corresponds with each query field 302, 304, 306 within the query 103.

In addition to accessing data requested by a query 103, the query a processor 105 can also apply a filter to a hierarchal data structure. For example, a particular user may only be given permission to access information that is “downstream” from the user (i.e., below the user in the hierarchy structure). Accordingly, in at least one implementation, the query processor can automatically filter any queries 103 received from a user to only access the information that the user is allowed to access. Similarly, a filter may also be set to restrict access to specific data fields. In at least one implementation, a specific data field may be representative of a particular column within an ordered flat file. For example, a particular data structure may contain personal information relating to other employees. As such, a filter can be set that would block access to data fields that contain personal information, but allow access to other pertinent fields.

An intelligent filter can also be created that only applies itself if certain conditions are met. For example, a hierarchal data structure might contain entries about individuals from a diversity of different countries, and each entries might contain data fields directed towards various statistics and information related to the individual. It might be desirable to restrict access to certain data elements based upon the jurisdiction, and accompanying privacy laws, that are associated with each individual represented within the hierarchal data structure. Accordingly, an intelligent filter can be designed that would only be applied if a particular record meets certain requirements. For example, the intelligent filter can first access a data field relating to “residential address,” and based upon the address of the individual determine whether the filter should be applied to that record. Accordingly, various types and configurations of filters can be created that control the access of information from within a hierarchal data structure.

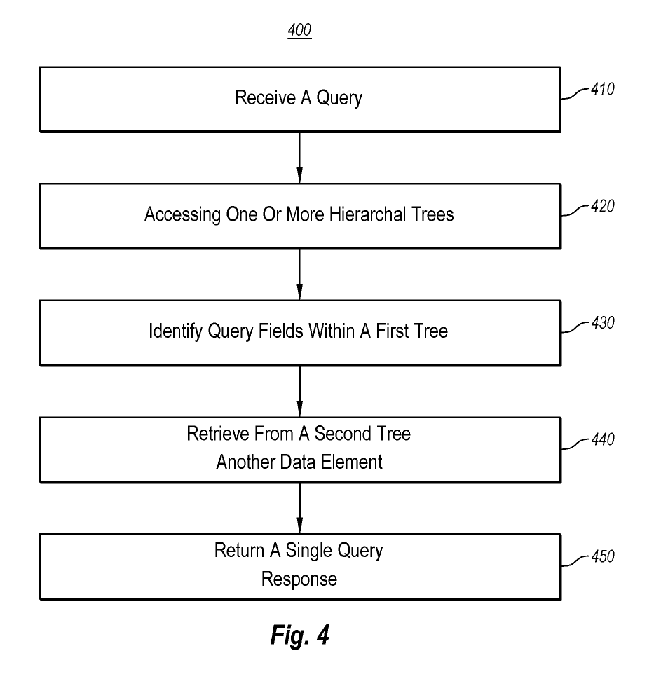

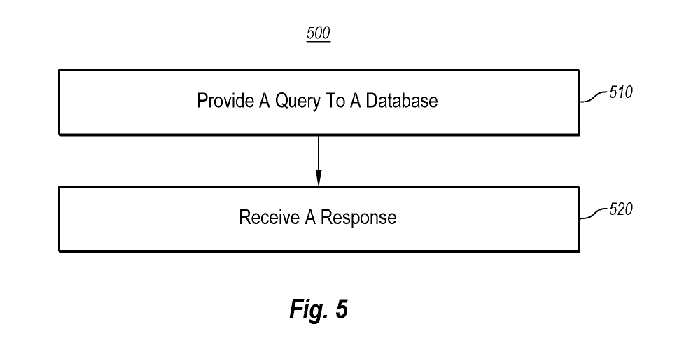

Accordingly, FIGS. 1-3 and the corresponding text illustrate or otherwise describe one or more methods, systems, and/or instructions stored on a storage medium for accessing multiple hierarchal data structures using a single query. One will appreciate that implementations of the present invention can also be described in terms of methods comprising one or more acts for accomplishing a particular result. For example, FIGS. 4 and 5 and the corresponding text illustrate flowcharts of a sequence of acts in a method for accessing data elements within a hierarchal tree structure. The acts of FIGS. 4 and 5 are described below with reference to the components and modules illustrated in FIGS. 1-3.

For example, FIG. 4 illustrates that a flow chart for an implementation of a method for expediting the resolution of the queries against the hierarchically organized elements can comprise an act 400 of receiving a query. Act 400 includes receiving a database query comprising multiple query fields. At least one of the query fields can be directed towards information stored within a first hierarchal tree, and another of the query fields can be directed towards information stored within a separate, second hierarchal tree. For example, in FIG. 3 and the accompanying description, query 103 includes field x query 302 and field y query 304, which are directed towards ordered flat file 310, and field z query 306, which is directed towards ordered data file 320.

FIG. 4 also shows that the method can comprise an act 410 of accessing one or more hierarchal trees. Act 410 includes accessing one or more files containing the first hierarchal tree and the second hierarchal tree. For example, in FIG. 3 and the accompanying description, the query processor 105 accesses one or more files that are associated with order flat file 310 and ordered flat file 320.

Additionally, FIG. 4 shows that the method can include an act 410 of identifying query fields within a first tree. Act 420 includes identifying a first group of query fields that are contained within the first hierarchal tree and a second group of query fields that are not contained within the first hierarchal tree. The first group of query fields and the second group of query fields can be selected from the multiple query fields. Also, at least one of the query fields is within the first group of query fields. For example, in FIG. 3 and the accompanying description, the query processor 105 identifies that field x query 302 and field y query 304 are both located within ordered flat file 310, and that field z query is located within ordered flat file 320.

FIG. 4 also shows that the method can include an act 430 of retrieving from a first tree a data element. Act 430 includes retrieving, from the first hierarchal tree, a first set of data entries from one or more query fields that are within the first group of query fields. For example, in FIG. 3 and the accompanying description, the query processor 105 retrieves data from data fields 312 and 314 within ordered flat file 310.

Further, FIG. 4 shows that the method can include an act 440 of retrieving from a second tree a data element. Act 440 includes retrieving, from the second hierarchal tree, a second set of data entries from one or more query fields that are within the second group of query fields. For example, in FIG. 3 and the accompanying description, the query processor 105 accesses data field 326 within ordered flat file 320.

Further still, FIG. 4 shows that the method can include an act 450 of returning a single query response. Act 450 includes transmitting a single query response that comprises the first set of data entries and the second set of data entries. The first set of data entries and the second set of data entries are responsive to the database query. For example in, FIGS. 1 and 3, and the accompanying description, the query processor 105 transmits a query result 109 back to the user application 102.

In at least one implementation a user application can be used to perform at least a portion of the described method. For example, FIG. 5 illustrates that a flow chart for an implementation of a method for receiving data entries responsive to queries against a hierarchically organized data trees can comprise an act 500 of providing a query to a database. Act 500 includes providing a single query to a database system. The single query can be directed towards returning one or more data elements from more than one query fields. The single query can address both a first query field, which is located within a first hierarchal tree, and a second query, which is not located within the first hierarchal tree. For example, in FIG. 3 and the accompanying description, a query 103 is provided to the query processor. The query includes query fields 320, 304 that are addressed towards a first ordered flat file 310, and query field 306 that is addressed towards a second ordered flat file 320.

FIG. 5 also shows that the method can comprise an act 510 of receiving a response. Act 510 includes receiving a single query response from the database system. The single query response can comprise more than one data elements. In particular, the single query response can comprise a first data element from the first query field that is location within the first hierarchal tree and a second data element from the second query field that is located within the second hierarchal tree. For example, in FIG. 3, and the accompanying description, results 109 are transmitted back to the user application 102. The user results include data from both the ordered flat file 310 (e.g., data field 312 and data field 314) and the ordered flat file 320 (e.g., data field 326).

Accordingly, one or more implementations of the present invention provide users with methods and systems for quickly searching multiple hierarchal tree structures with a single query. In particular, one will understand the benefit that can be gained by allowing users to access complex hierarchal data bases without necessarily needing to know what data fields are contained within what specific tree structures.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two a distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of“cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

We claim:

1. At a server computer system that receives queries from one or more client computers for accessing hierarchically organized elements maintained in a database, a computerized method for expediting the resolution of the queries directed towards the hierarchically organized elements, comprising:
receiving a database query comprising multiple query fields wherein at least one of the query fields is directed towards information stored within a first hierarchal tree, and another of the query fields is directed towards information stored within a separate, second hierarchal tree;
identifying a first group of query fields that are contained within the first hierarchal tree and a second group of query fields that are not contained within the first hierarchal tree, wherein the first group of query fields and the second group of query fields are selected from the multiple query fields and wherein the at least one of the query fields is within the first group of query fields;
retrieving, from the first hierarchal tree, a first set of data entries from one or more data fields that are responsive to the first group of query fields;
retrieving, from the second hierarchal tree, a second set of data entries from one or more data fields that are responsive to the second group of queries; and
transmitting a single query response that comprises the first set of data entries and the second set of data entries, wherein the first set of data entries and the second set of data entries are responsive to the database query.

2. The method as recited in claim 1, further comprising reading a flat file header associated with the first hierarchal tree, wherein the flat file header comprises a listing of the data fields that are within the first hierarchal tree.

3. The method as recited in claim 1, wherein the first hierarchal tree is stored within an ordered flat file, wherein the ordered flat file maintains the hierarchical organization of the first hierarchical tree.

4. The method as recited in claim 3, wherein the at least one of the query fields is directed towards a set of data that comprises multiple individual entries that are stored within a single column of the ordered flat file.

5. The method as recited in claim 4, wherein each of the multiple individual entries that are stored within the single column are associated with a single data field.

6. The method as recited in claim 3, wherein the first set of data entries are directly accessed without traversing through a hierarchical organization.

7. The method as recited in claim 1, wherein retrieving the first set of data entries and the second set of data entries occurs simultaneously.

8. The method as recited in claim 1, further comprising:
accessing the first hierarchical tree through an alias,
wherein the alias is dynamically updated to address a most recent version of a particular hierarchical tree.

9. At a client computer console that retrieves data from one or more hierarchically organized data trees maintained in a database, a computerized method for receiving data entries responsive to queries against the hierarchically organized data trees, the method comprising:
providing a query to a database system, the query directed towards returning one or more data entries from more than one data fields;
wherein the query addresses both a first data field, which is located within a first hierarchal tree, and a second data field, which is not located within the first hierarchal tree; and
receiving a query response from the database system, the query response comprising more than one data entries;
wherein the query response comprises a first data entry from the first data field that is location within the first hierarchal tree and a second data entry from the second data field that is located within the second hierarchal tree.

10. The method as recited in claim 9, wherein the first hierarchal tree is stored within a first ordered flat file, wherein the first ordered flat file comprises information stored within the first hierarchical tree, including information associating each data entry within the first hierarchical tree with the data entry's relative position within the first hierarchical tree.

11. The method as recited in claim 10, wherein the second hierarchal tree is stored within a second ordered flat file, wherein the second ordered flat file comprises information stored within the second hierarchical tree, including information associating each data entry within the second hierarchical tree with the data entry's relative position within the second hierarchical tree.

12. The method as recited in claim 10, wherein a first flat file header is associated with the first ordered flat file, wherein the flat file header comprises a listing of the data fields that are within the first ordered flat file.

13. The method as recited in claim 12, wherein the first data field is directly accessed without traversing through a hierarchical organization.

14. The method as recited in claim 10, wherein the query is directed towards returning a set of data that comprises multiple individual entries that are stored within a single column of the first ordered flat file.

15. In a computerized environment, one or more computer storage products having computer-executable instructions stored thereon that, when executed cause one or more processors in a computer system to perform a method of expediting the resolution of the queries against the hierarchically organized elements, the method comprising the acts of:
receiving a database query comprising multiple query fields wherein at least one of the query fields is directed towards information stored within a first hierarchal tree, and another of the query fields is directed towards information stored within a separate, second hierarchal tree;
identifying a first group of query fields that are contained within the first hierarchal tree and a second group of query fields that are not contained within the first hierarchal tree, wherein the first group of query fields and the second group of query fields are selected from the multiple query fields and wherein the at least one of the query fields is within the first group of query fields;
retrieving, from the first hierarchal tree, a first set of data entries from one or more data fields that are responsive to the first group of query fields;
retrieving, from the second hierarchal tree, a second set of data entries from one or more data fields that are responsive to the second group of queries;
transmitting a single query response that comprises the first set of data entries and the second set of data entries, wherein the first set of data entries and the second set of data entries are responsive to the database query.
